(19) United States
(12) Patent Application Publication
(10) Pub. No.: US 2014/0058955 A1
(43) Pub. Date: Feb. 27, 2014

(54) READABLE INDICIA FOR PRODUCT REGISTRATION

(71) Applicant: Matthew A. Calman, Charlotte, NC (US)

(72) Inventor: Matthew A. Calman, Charlotte, NC (US)

(73) Assignee: Bank of America Corporation, Charlotte, NC (US)

(21) Appl. No.: 13/595,413

(22) Filed: Aug. 27, 2012

(51) Int. Cl. G06Q 10/00; G06Q 99/00

(52) U.S. Cl. 705/302; 705/317

(57) ABSTRACT

Embodiments of the invention are directed to systems, methods and computer program products for processing readable indicia for product registration. An exemplary system is configured to: receive information associated with readable indicia associated with a purchase; and process the readable indicia to initiate registration of a product associated with the purchase. As used herein, product registration may comprise product registration and user registration.

### BACKGROUND

There is a need to make it easier for a user to register a product (e.g., for warranty registration).

### BRIEF SUMMARY

Embodiments of the invention are directed to systems, methods and computer program products for processing readable indicia associated with a product or service purchase. An exemplary system is configured to: receive information associated with readable indicia associated with a purchase; and process the readable indicia to initiate registration of a product associated with the purchase.

In some embodiments, the registration comprises warranty registration.

In some embodiments, the warranty registration comprises warranty service associated with a plurality of entities.

In some embodiments, the readable indicia comprises at least one of a serial number, a model number, a purchase date, a product category, a product name, a merchant name, a merchant identification code, a receipt identification code, a retailer name, an address of the retailer, a retailer identification code, a manufacturer name, a manufacturer identification code, a country of origin name or code, or other source code.

In some embodiments, the readable indicia comprises at least one of a name of a user or contact information associated with the user, wherein the user made the purchase.

In some embodiments, the readable indicia comprises at least one of a type of warranty associated with the product or a warranty expiration date, wherein the type of warranty is selected by a user or automatically selected based on a pre-established user preference.

In some embodiments, the purchase is registered without receiving manual input from the user.

In some embodiments, the readable indicia comprises a Quick Response (QR) code.

In some embodiments, the readable indicia is comprised in a tag that transmits information wirelessly.

In some embodiments, the apparatus comprises a portable mobile communication apparatus that comprises an image-capturing component, and wherein the image of the readable indicia is captured by the portable mobile communication apparatus.

In some embodiments, the processing occurs either inside or outside the portable mobile communication apparatus.

In some embodiments, the readable indicia comprises electronic readable indicia.

In some embodiments, the electronic readable indicia is transmitted via at least one of email or text or multimedia message.

In some embodiments, the readable indicia comprises physical readable indicia.

In some embodiments, the physical readable indicia is printed on a receipt, on the product, or on a packaging associated with the product.

In some embodiments, the module is further configured to: extract a link from the readable indicia; and initiate a user interface associated with the link.

In some embodiments, the name of the user or the contact information associated with the user is extracted from payment information used by the user to make the purchase.

In some embodiments, the module is further configured to: receive authentication credentials associated with the registration of the product; and the module configured to process the readable indicia is further configured to process the readable indicia and the authentication credentials to authorize the registration of the product.

In some embodiments, the module is further configured to process the readable indicia and the authentication credentials to enable use of the product.

In some embodiments, the product comprises at least one of a product or a service.

In some embodiments, the module is further configured to prompts the user to associate at least one of an account or an alias with the product.

In some embodiments, a method is provided for processing readable indicia for registering a product or service purchase. The method comprises receiving information associated with readable indicia associated with a purchase; and processing the readable indicia to initiate registration of a product or service associated with the purchase

In some embodiments, a computer program product is provided for registering a product or service purchase. The computer program product comprises a non-transitory computer-readable medium comprising a set of codes for causing a computer to: receive information associated with readable indicia associated with a purchase; and process the readable indicia to initiate registration of a product or service associated with the purchase.

### BRIEF DESCRIPTION OF THE DRAWINGS

Having thus described embodiments of the invention in general terms, reference will now be made to the accompanying drawings, where:

FIG. 1 is a flowchart illustrating a general process flow for processing readable indicia, in accordance with embodiments of the present invention; and

FIG. 2 is a block diagram illustrating technical components of a system for processing readable indicia, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for processing readable indicia associated with product or service registration. In some embodiments, the readable indicia comprises a code (e.g., barcode, Quick Response (QR) code, or the like). As used herein, a product may refer to at least one of a product or a service, and a service may refer to at least one of a service or a product.

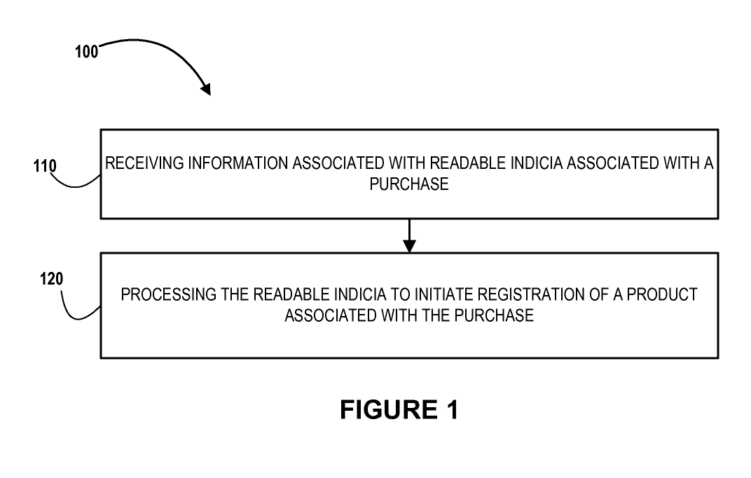

Referring now to FIG. 1, a general process flow 100 is provided for processing readable indicia associated with product registration. At block 110, the method comprises receiving information associated with readable indicia associated with a purchase from a merchant. Although, the registration is described as a product registration, the registration may additionally or alternatively comprise a service registration. Therefore, the purchase may comprise at least one of a product or a service. In some instances, the merchant may impose a deadline on the user such that the user has a predetermined number of days after the purchase to register the purchase. In some embodiments, the user registers a purchased product in order to receive news about the product (or the merchant), to receive updates (e.g., software updates) associated with the product, or the like. In some embodiments, the registration may be warranty registration, e.g., registering warranty service associated with a purchased product.

In some embodiments, the readable indicia is attached to the purchase (e.g., the purchased product). In other embodiments, the merchant or retailer associated with the purchase sends readable indicia to the user. The readable indicia may be received by the user from the merchant either in physical form (e.g., on paper such as a receipt) or in electronic form (e.g., an electronic receipt received via email, text or multimedia message, or the like). In some embodiments, the readable indicia comprises visual indicia, e.g., a barcode, a Quick Response (QR) code, or the like. The readable indicia may comprise any one-dimensional or two-dimensional code. Therefore, the user may use a portable mobile communication device or apparatus (“mobile device”) that comprises an image-capturing component (e.g., a camera) to capture the image of the readable indicia. In some embodiments, this readable indicia is stored in the mobile device. In other embodiments, this readable indicia is automatically transmitted to an external server.

In embodiments where the readable indicia is in electronic form, the readable indicia may be dynamically generated after the user selects an option to view the readable indicia. For example, an electronic receipt is presented on the user's mobile device, and the user may select an option, on the mobile device, to view readable indicia associated with the electronic receipt.

In some embodiments, either before or after the purchase, a user may answer a series of questions (e.g., a feedback form) at a store kiosk in order to receive the readable indicia. Once the user has completed answering the questions, the store kiosk presents readable indicia. The user may receive information associated with the presented readable indicia using a portable mobile communication device.

In some embodiments, the readable indicia may be presented at the point-of-sale terminal (e.g., on a video display or on a static display (e.g., a sticker)). When the readable indicia is presented on a point-of-sale terminal, the readable indicia may be dynamic such that the readable indicia presented to one user may be different from the readable indicia presented to another user. The readable indicia may be presented at least one of prior to, during, or after the purchase. In some embodiments, the readable indicia is presented after the user leaves the premises of the merchant. In some embodiments, the readable indicia is presented on companion materials or companion products associated with the purchase (e.g., on a manual).

The readable indicia may comprise any indicia, visual or non-visual, where information associated with the indicia is receivable or readable (e.g., scannable) by the mobile device. For example, the readable indicia is comprised in a tag (e.g., radio frequency identification (RFID) tag, near field communication (NFC) tag, or the like). A user may bring a mobile device in close proximity to the tag in order to receive information (e.g., readable indicia) associated with the tag.

The readable indicia comprises information associated with the product, the merchant, or the retailer. For example, the readable indicia comprises at least one of a serial number, a model number, a purchase date, a product category, a product name, a merchant name, a merchant identification code, a receipt identification code, a retailer name, an address of the retailer, a retailer identification code, a manufacturer name, a manufacturer identification code, a country of origin name or code, or other source code associated with the purchase. As used herein, an identification code comprises identification information. As used herein, a retailer sells products associated with one or more merchants. When the purchase is a vehicle, the serial number may be a vehicle identification number.

Additionally or alternatively, the readable indicia comprises at least one of a type of warranty associated with the product and a warranty expiration date. The user may select the type of warranty either at the point of purchase (e.g., at the point-of-sale terminal), prior to purchase, or after the purchase. The type of warranty may include a duration associated with a warranty period (e.g., two years, five years, or the like) or a type of coverage associated with repair or restoration of a product (e.g., parts and/or labor). In some embodiments, the type of warranty may be automatically selected for the user based on pre-established user preferences. For example, the user may have previously established user preferences on a user account associated with the merchant. In some embodiments, the type of warranty may be based on eligibility of the product. For example, a first product may be eligible for warranty where both parts and service are covered, while a second product may be eligible for warranty where only parts are covered and service is not covered, while a third product may be eligible for warranty where only service is covered and parts are not covered.

In some embodiments, the readable indicia comprises warranty information (or links to warranty information) associated with the manufacturer, warranty information (or links to warranty information) associated with the retailer, warranty information (or links to warranty information) associated with a warranty service provider, or the like. Additionally, the readable indicia my comprise a link to a manual associated with the product. Additionally, the readable indicia may comprise links to software updates. Additionally, the readable indicia may comprise transaction information (e.g., a purchase receipt) or a link to transaction information associated with the purchase. Therefore, upon receiving the readable indicia, the user's mobile device pre-fills a form with the information comprised in the readable indicia. The user may be able to view and/or edit this information, while in other embodiments, the user may not be able to view and/or edit this information. Therefore, the present invention makes product registration easier because a user does not have to manually fill multiple forms associated with warranty services associated with multiple entities (e.g., manufacturer, retailer, warranty service provider, or the like).

Additionally or alternatively, the readable indicia may comprise at least one of a name of a user or contact information associated with the user associated with the purchase. Additionally or alternatively, the readable indicia may comprise account information (e.g., a financial institution account, a user account associated with the merchant, or the like) associated the user. The account (e.g., the financial institution account or a payment card associated with the financial institution account) may have been used by the user to make the purchase. The name or contact information may be obtained from account information associated with the user.

In some embodiments, upon receiving the readable indicia, the mobile device, either on its own or in combination with the external server, automatically registers the purchase without any manual input from the user. Therefore, the user does not need to manually input information associated with at least one of the product, the merchant, the retailer, or the user.

In some embodiments, the readable indicia may be processed by at least one of the mobile device or the external server to determine a link (e.g., a hyperlink) associated with the readable indicia. The user interface of the mobile device may present the link and may prompt the user to visit the link. The link may transport the user to a user interface page for initiating the process of registering the product. In some embodiments, the readable comprises information associated with at least one of the user, the merchant, or the purchase. Additionally or alternatively, the user interface may prompt the user to enter information associated with at least one of the user, the merchant, or the purchase.

In some embodiments, at block 110, the method additionally comprises receiving authentication credentials associated with the product registration. In some embodiments, in response to receiving the readable indicia, the mobile device initiates an authentication prompt (e.g., at the link described above) for receiving the authentication credentials from the user. For example, the authentication prompt may comprise a prompt or challenge question for which the user knows the answer. These authentication credentials may have been previously received from the merchant separately from or together with the readable indicia. For example, the merchant may have sent a personal identification number (“PIN”) code to the user via mail, email, text or multimedia message, or the like. As a further example, the user may have previously logged onto the merchant's website in order to set up authentication credentials for registering the product. In some embodiments, the authentication credentials may be printed on the product or on the receipt associated with purchasing the product.

Subsequently, the user inputs authentication credentials onto a user interface of the mobile device. In some embodiments, this input may comprise entering a password. In some embodiments, this input may comprise entering an alias. For example, the alias may comprise a phone number, email address, or social networking identification information associated with the user. In other embodiments, this input may comprise entering an answer to a question. In still other embodiments, this input may comprise selecting a picture. In some embodiments, the received authentication credentials are stored in the mobile device. In other embodiments, the received authentication credentials are automatically transmitted to an external server. In some alternate embodiments, the user may input authentication credentials on a user interface of the mobile device prior to the mobile device receiving the readable indicia described herein.

At block 120, the method comprises processing the readable indicia to initiate registration of a product associated with the purchase. In embodiments where the readable indicia is stored in the mobile device, the processing of the readable indicia occurs in the mobile device. In embodiments where the readable indicia is transmitted to an external server, the processing of the readable indicia occurs outside the mobile device, i.e., at the external server. The processing may comprise comparing the information associated with the readable indicia to information stored in at least one of the mobile device or the external server to determine whether to initiate registration of the product.

As described previously, in some embodiments, the user is prompted to enter authentication credentials on the mobile device user interface. Prior to enabling the user to enter the authentication credentials, one or more mobile interface pages of advertisements may be presented to the user. These advertisements may be associated with the merchant associated with the purchase. In some embodiments, the method, at block 120, further comprises processing the authentication credentials to authorize registration of the product. In embodiments where the authentication credentials are stored in the mobile device, the processing of the authentication credentials occurs in the mobile device. In embodiments where the authentication credentials are transmitted to an external server, the processing of the authentication credentials occurs outside the mobile device, i.e., at the external server. The processing comprises comparing the authentication credentials to information stored in at least one of the mobile device or the external server.

In some embodiments, authentication credentials are comprised in the readable indicia. Therefore, the authentication credentials input by the user are compared to the authentication credentials extracted from the readable indicia. In other embodiments, the authentication credentials are not comprised in the readable indicia. In such embodiments, the authentication credentials input by the user are compared to information (e.g., authentication credentials) stored in at least one of the mobile device or external server or accessed by at least one of the mobile device or external server from an external datastore.

If the mobile device or the external server determines a match between the authentication credentials input by the user and the authentication credentials either extracted from the readable indicia or stored in at least one of the mobile device or external server, the registration of the product is authorized. Therefore, either the product is automatically registered upon receiving the readable indicia at the mobile device, or the user may need to enter more information (e.g., information associated with the merchant, the user, or the product) to authorize registration of the product. In alternate embodiments, the product is authorized for registration without executing the authentication step described herein.

In some embodiments, either prior to, during, or after processing the readable indicia, the mobile device may initiate selection of an account or input of account information (e.g., a financial institution account) to link to the user's product registration. In some embodiments, prior to enabling the user to select an account or input account information, one or more mobile interface pages of advertisements may be presented to the user. In some embodiments, the account or a payment card associated with the account may or may not have been used to purchase the product.

In some embodiments, either prior to, during, or after processing the readable indicia, the user provides an alias to link to the product registration. For example, the alias may comprise a phone number, email address, or social networking identification information associated with the user. In some embodiments, prior to enabling the user to provide an alias, one or more mobile interface pages of advertisements may be presented to the user.

The purchased product may be a network-connectable computing device (e.g., a toaster, a laptop, a DVD player, or the like). A network-connectable computing device may be referred to as an Internet Protocol (IP) addressable device. In some embodiments, the readable indicia comprises authentication credentials for use of the product on an authorized network (e.g., a home network). In other embodiments, upon receiving the readable indicia using the user's mobile device, the processing of the readable indicia prompts initiation of a user interface on the user's mobile device where the user creates authentication credentials (e.g., username and password) for the device. The authentication credentials may be for using the device or for accessing the network (e.g., sharing data and/or communicating with other network-connected devices on the network). Therefore, the present invention enables a user to create authentication credentials using a mobile device user interface rather than using a user interface associated with the purchased device. As used herein, registration may refer to at least one of product registration or user registration (e.g. creation of authentication credentials for using the device). As used herein, product registration may comprise at least one of product registration or user registration.

As used herein, a mobile device may refer to any computing device. Therefore, a first device that has previously been authorized to use the network (e.g., a network-connectable tablet computing device) may be used to register a second device (e.g., a network-connectable toaster). As used herein, registration may comprise at least one of product or user registration. Therefore, the first device may receive readable indicia associated with the second device. In some embodiments, the first device may capture an image of or scan the readable indicia associated with the second device. In some embodiments, the second device may transmit readable indicia to the first device (e.g., over the network). Subsequently, the first device may pre-fill a registration form and transmit the registration form to the merchant (e.g., a system associated with the merchant) to register the second device. Additionally, the first device may enable the user to create authentication credentials for use of the second device. Upon registration of the second device and/or user, the second device (and/or the first device) may automatically download software (e.g., software updates) for enabling use of the second device.

In some embodiments, a purchased device may be used to register itself (e.g, product registration, user registration, or the like). For example, readable indicia associated with the device may be located on a packaging (e.g., box) or companion materials (or devices) or on a purchase transaction receipt associated with the device. Therefore, the device may receive readable indicia located on the packaging (e.g., box) or companion materials (or devices) or on a purchase transaction receipt, and transmit the readable indicia to the merchant in order to register the device.

In some embodiments, authentication credentials are associated with a user's account (e.g., financial institution account). When the user logs into the user's account using authentication credentials, the user may access a product registration user interface. The form associated with the product registration user interface may be automatically filled using information associated with the readable indicia and/or information associated with the account. The user may then select an option to transmit the form to the merchant to register the product. The user may authenticate into the user's account (e.g., mobile account) either prior to or after enabling the user's mobile device to receive the readable indicia.

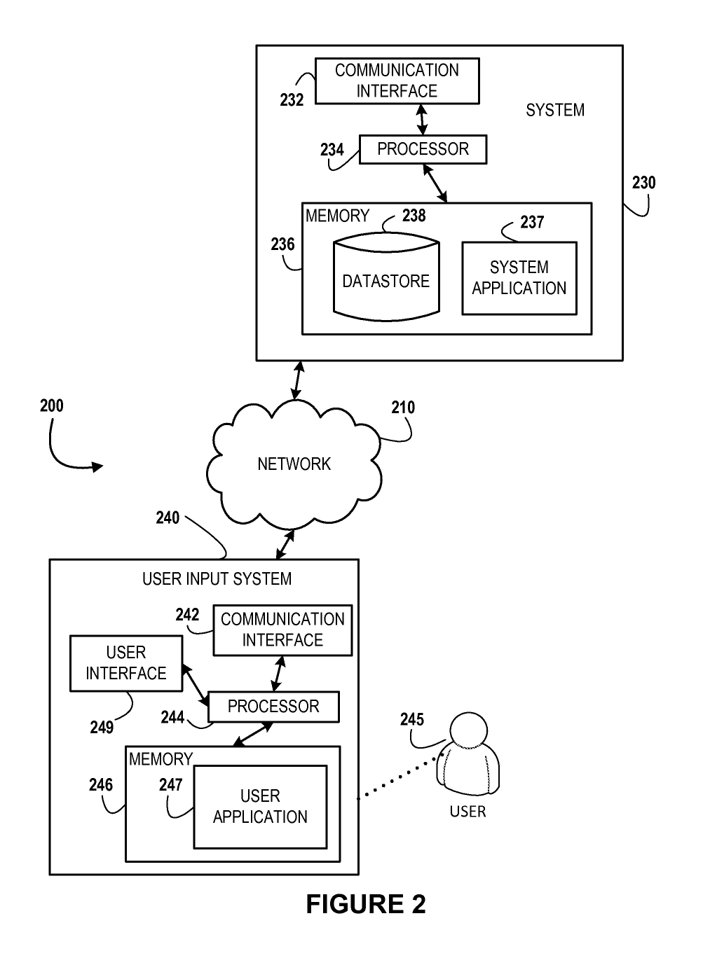

Referring now to FIG. 2, FIG. 2 presents an exemplary block diagram of the system environment 200 for implementing the process flow 100 described in FIG. 1, in accordance with embodiments of the present invention. As illustrated, the system environment 200 includes a network 210, a system 230, and a user input system 240. Also shown in FIG. 2 is a user 245 of the user input system 240. The user input system 240 may be a mobile device described herein. The user 245 may be a person who uses the user input system 240 to execute a user application 247. The system 230 may be the external server described herein. The system 230 may be associated with and/or managed (or controlled) by at least one of the merchant, a financial institution, or the like. The user application 247 and/or the system application 237 may incorporate one or more parts of the process flow 100 or any other function described herein.

As shown in FIG. 2, the system 230, and the user input system 240 are each operatively and selectively connected to the network 210, which may include one or more separate networks. In addition, the network 210 may include a local area network (LAN), a wide area network (WAN), and/or a global area network (GAN), such as the Internet. The network may also include a mobile telecommunication network. It will also be understood that the network 210 may be secure and/or unsecure and may also include wireless and/or wireline and/or optical interconnection technology.

The user input system 240 may include any computerized apparatus that can be configured to perform any one or more of the functions of the user input system 240 described and/or contemplated herein. For example, the user 245 may use the user input system 240 to transmit and/or receive information or commands to and from the system 230. In some embodiments, for example, the user input system 240 may include a personal computer system, a mobile computing device, a personal digital assistant, a mobile phone, a network device, and/or the like. As illustrated in FIG. 2, in accordance with some embodiments of the present invention, the user input system 240 includes a communication interface 242, a processor 244, a memory 246 having an user application 247 stored therein, and a user interface 249. In such embodiments, the communication interface 242 is operatively and selectively connected to the processor 244, which is operatively and selectively connected to the user interface 249 and the memory 246. In some embodiments, the user 245 may use the user application 247 to execute processes described with respect to the process flows described herein.

Each communication interface described herein, including the communication interface 242, generally includes hardware, and, in some instances, software, that enables the user input system 240, to transport, send, receive, and/or otherwise communicate information to and/or from the communication interface of one or more other systems on the network 210. For example, the communication interface 242 of the user input system 240 may include a wireless transceiver, modem, server, electrical connection, and/or other electronic device that operatively connects the user input system 240 to another system such as the system 230. The wireless transceiver may include a radio circuit to enable wireless transmission and reception of information.

Each processor described herein, including the processor 244, generally includes circuitry for implementing the audio, visual, and/or logic functions of the user input system 240. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 247 of the memory 246 of the user input system 240.

Each memory device described herein, including the memory 246 for storing the user application 247 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 2, the memory 246 includes the user application 247. In some embodiments, the user application 247 includes an interface for communicating with, navigating, controlling, configuring, and/or using the user input system 240. In some embodiments, the user application 247 includes computer-executable program code portions for instructing the processor 244 to perform one or more of the functions of the user application 247 described and/or contemplated herein. In some embodiments, the user application 247 may include and/or use one or more network and/or system communication protocols.

Also shown in FIG. 2 is the user interface 249. In some embodiments, the user interface 249 includes one or more output devices, such as a display and/or speaker, for presenting information to the user 245. In some embodiments, the user interface 249 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 245. In some embodiments, the user interface 249 includes the input and display devices of a mobile device, which are operable to receive and display information.

FIG. 2 also illustrates a system 230, in accordance with an embodiment of the present invention. The system 230 may include any computerized apparatus that can be configured to perform any one or more of the functions of the system 230 described and/or contemplated herein. In accordance with some embodiments, for example, the system 230 may include a computer network, an engine, a platform, a server, a database system, a front end system, a back end system, a personal computer system, and/or the like. Therefore, the system 230 may be an external server as described herein. In some embodiments, such as the one illustrated in FIG. 2, the system 230 includes a communication interface 232, a processor 234, and a memory 236, which includes a system application 237 and a datastore 238 stored therein. As shown, the communication interface 232 is operatively and selectively connected to the processor 234, which is operatively and selectively connected to the memory 236.

It will be understood that the system application 237 may be configured to implement any one or more portions of the various user interfaces and/or process flow described herein. The system application 237 may interact with the user application 247. It will also be understood that, in some embodiments, the memory includes other applications. It will also be understood that, in some embodiments, the system application 237 is configured to communicate with the datastore 238, the user input system 240, or the like.

It will be further understood that, in some embodiments, the system application 237 includes computer-executable program code portions for instructing the processor 234 to perform any one or more of the functions of the system application 237 described and/or contemplated herein. In some embodiments, the system application 237 may include and/or use one or more network and/or system communication protocols.

In addition to the system application 237, the memory 236 also includes the datastore 238. As used herein, the datastore 238 may be one or more distinct and/or remote datastores. In some embodiments, the datastore 238 is not located within the system and is instead located remotely from the system. In some embodiments, the datastore 238 stores information or data described herein.

It will be understood that the datastore 238 may include any one or more storage devices, including, but not limited to, datastores, databases, and/or any of the other storage devices typically associated with a computer system. It will also be understood that the datastore 238 may store information in any known way, such as, for example, by using one or more computer codes and/or languages, alphanumeric character strings, data sets, figures, tables, charts, links, documents, and/or the like. Further, in some embodiments, the datastore 238 may include information associated with one or more applications, such as, for example, the system application 237. It will also be understood that, in some embodiments, the datastore 238 provides a substantially real-time representation of the information stored therein, so that, for example, when the processor 234 accesses the datastore 238, the information stored therein is current or substantially current.

It will be understood that the embodiment of the system environment illustrated in FIG. 2 is exemplary and that other embodiments may vary. As another example, in some embodiments, the system 230 includes more, less, or different components. As another example, in some embodiments, some or all of the portions of the system environment 200 may be combined into a single portion. Likewise, in some embodiments, some or all of the portions of the system 230 may be separated into two or more distinct portions.

In addition, the various portions of the system environment 200 may be maintained for and/or by the same or separate parties. It will also be understood that the system 230 may include and/or implement any embodiment of the present invention described and/or contemplated herein. For example, in some embodiments, the system 230 is configured to implement any one or more of the embodiments of the process flow 100 described and/or contemplated herein in connection with FIG. 1 or any other process flow described herein. Additionally, the system 230 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. An apparatus for processing readable indicia, the apparatus comprising:
a memory;
a processor; and
a computing module stored in the memory, executable by the processor, and configured to:
receive information associated with readable indicia associated with a purchase of a product by a user, wherein the product comprises a computing device for use on a network associated with the user and wherein the readable indicia comprises product information associated with the product, user information associated with the user, and authentication credentials for use of the product on the network, wherein the user information comprises a name and contact information of the user, wherein the name and contact information of the user are extracted from payment information used by the user to purchase the product, and wherein receipt of the information associated with the readable indicia triggers pre-filling of a form with the product information, the user information, and the authentication credentials; and
process the readable indicia to initiate registration of the product and to initiate use of the product on the network without receiving manual input of the product information, the user information, and the authentication credentials from the user, wherein initiating use of the product on the network comprises initiating download of software for enabling use of the product on the network, and wherein using the product on the network comprises sharing data with other computing devices on the network.

2. The apparatus of claim 1, wherein the registration comprises warranty registration.

3. The apparatus of claim 2, wherein the warranty registration comprises warranty service associated with a plurality of entities.

4. The apparatus of claim 1, wherein the readable indicia comprises at least one of a serial number, a model number, a purchase date, a product category, a product name, a merchant name, a merchant identification code, a receipt identification code, a retailer name, an address of the retailer, a retailer identification code, a manufacturer name, a manufacturer identification code, a country of origin name or code, or other source code.

5. (canceled)

6. The apparatus of claim 1, wherein the readable indicia comprises at least one of a type of warranty associated with the product or a warranty expiration date, wherein the type of warranty is selected by the user or automatically selected based on a pre-established user preference.

7. The apparatus of claim 1, wherein the readable indicia comprises a Quick Response (QR) code.

8. The apparatus of claim 1, wherein the readable indicia is comprised in a tag that transmits information wirelessly.

9. The apparatus of claim 1, wherein the apparatus comprises a portable mobile communication apparatus that comprises an image-capturing component, and wherein the image of the readable indicia is captured by the portable mobile communication apparatus, wherein the processing occurs either inside or outside the portable mobile communication apparatus.

10. The apparatus of claim 1, wherein the readable indicia comprises electronic readable indicia.

11. The apparatus of claim 10, wherein the electronic readable indicia is transmitted via at least one of email or text or multimedia message.

12. The apparatus of claim 1, wherein the readable indicia comprises physical readable indicia, wherein the physical readable indicia is printed on a receipt, on the product, on companion materials associated with the product, or on a packaging associated with the product.

13. The apparatus of claim 1, wherein the readable indicia associated with the purchase is received at least one of prior to, during, or after the purchase.

14. The apparatus of claim 1, wherein the module is further configured to:
extract a link from the readable indicia; and
initiate a user interface associated with the link.

15. (canceled)

16. The apparatus of claim 1, wherein the module is further configured to:
receive second authentication credentials associated with the registration of the product; and wherein the module configured to process the readable indicia is further configured to:
process the readable indicia and the second authentication credentials to authorize the registration of the product.

17. The apparatus of claim 1, wherein the apparatus was registered for use on the network prior to receiving the information associated with the readable indicia.

18. The apparatus of claim 1, wherein the module is further configured to prompt the user to associate at least one of an account or an alias with the product.

19. A method for processing readable indicia, the method comprising:
receiving, at a computing device, information associated with readable indicia associated with a purchase of a product by a user, wherein the product comprises a computing device for use on a network associated with the user and wherein the readable indicia comprises product information associated with the product, user information associated with the user, and authentication credentials for use of the product on the network, wherein the user information comprises a name and contact information of the user, wherein the name and contact information of the user are extracted from payment information used by the user to purchase the product, and wherein receipt of the information associated with the readable indicia triggers pre-filling of a form with the product information, the user information, and the authentication credentials; and
processing, using the computing device, the readable indicia to initiate registration of the product and to initiate use of the product on the network without receiving manual input of the product information, the user information, and the authentication credentials from the user, wherein initiating use of the product on the network comprises initiating download of software for enabling use of the product on the network, and wherein using the product on the network comprises sharing data with other computing devices on the network.

20. A computer program product for processing readable indicia, the computer program product comprising:
a non-transitory computer-readable medium comprising a set of codes for causing a computer to:
receive information associated with readable indicia associated with a purchase of a product by a user, wherein the product comprises a computing device for use on a network associated with the user and wherein the readable indicia comprises product information associated with the product, user information associated with the user, and authentication credentials for use of the product on the network, wherein the user information comprises a name and contact information of the user, wherein the name and contact information of the user are extracted from payment information used by the user to purchase the product, and wherein receipt of the information associated with the readable indicia triggers pre-filling of a form with the product information, the user information, and the authentication credentials; and
process the readable indicia to initiate registration of the product and to initiate use of the product on the network without receiving manual input of the product information, the user information, and the authentication credentials from the user, wherein initiating use of the product on the network comprises initiating download of software for enabling use of the product on the network, and wherein using the product on the network comprises sharing data with other computing devices on the network.
